(19) United States
(12) Patent Application Publication
(10) Pub. No.: US 2017/0149753 A1
(43) Pub. Date: May 25, 2017

(54) HOTSPOT INFORMATION ANALYSIS METHOD AND APPARATUS AND COMPUTER STORAGE MEDIUM

(71) Applicant: BAIDU ONLINE NETWORK TECHNOLOGY (BEIJING) CO., LTD., Beijing (CN)

(72) Inventors: Xiaoyuan Wang, Beijing (CN); Chengze CHEN, Beijing (CN); Haoping QIU, Beijing (CN); Yang WANG, Beijing (CN); Jinhua TANG, Beijing (CN)

(73) Assignee: BAIDU ONLINE NETWORK TECHNOLOGY (BEIJING) CO., LTD., Beijing (CN)

(21) Appl. No.: 15/318,956

(22) PCT Filed: Jan. 14, 2015
(86) PCT No.: PCT/CN2015/070690

§ 371 Date: Dec. 14, 2016

(30) Foreign Application Priority Data
Jun. 23, 2014 (CN) 201410283286.9

(51) Int. Cl. H04L 29/06; G06F 17/30

(52) U.S. Cl. CPC H04L 63/08; G06F 17/30864; G06Q 40/04

(57) ABSTRACT

The present disclosure provides a hotspot information analysis method and apparatus and a computer storage medium. The hotspot information analysis method comprises: extracting, from Internet data, hotspot data describing a hotspot event; performing analysis for association of business data in the whole business market related to a business transaction and the hotspot data, and obtaining a correspondence relationship between candidate hotspot data and candidate business data, wherein the candidate hotspot data refers to hotspot data in the hotspot data related to the business transaction, and the candidate business data refers to business data in the business data related to the hotspot event; merging and processing the candidate hotspot data according to the correspondence relationship between the candidate hotspot data and candidate business data, and obtaining target hotspot data and target business data corresponding to the target hotspot data. The technical solution of the present disclosure performs analysis of the hotspot information and improves accuracy of the hotspot information resulting from the analysis.

The present disclosure claims priority to the Chinese patent application No. 201410283286.9 entitled “Hotspot Information Method and Apparatus” filed on the filing date Jun. 23, 2014, the entire disclosure of which is hereby incorporated by reference in its entirety.

### FIELD OF THE DISCLOSURE

The present disclosure relates to the technical field of the Internet, and particularly to a hotspot information analysis method and apparatus and a computer storage medium.

### BACKGROUND OF THE DISCLOSURE

As business market develops, hotspot information mining needs to be performed in more and more industries of business to facilitate performing business analysis and obtaining useful information. Take securities market as an example. Hotspot quotation in the securities market rises and falls hither and thither. In a current stage, shareholders perform judgment and analysis mainly based on securities market transaction data and news data they learn themselves and by virtue of business experience to obtain hotspot information in the securities market. At present, this method of analyzing hotspot information depends on the user's business experience on the one hand, and on the other hand, uses the data that can be learnt by the user and are in a relatively less amount. This causes accuracy of the hotspot information resulting from the analysis lower.

### SUMMARY OF THE DISCLOSURE

A plurality of aspect of the present disclosure provide a hotspot information analysis method and apparatus and a computer storage medium to perform analysis of the hotspot information and improve accuracy of the hotspot information resulting from the analysis.

According to an aspect of the present disclosure, there is provided a hotspot information analysis method, comprising:

extracting, from Internet data, hotspot data describing a hotspot event;

performing analysis for association of business data in the whole business market related to a business transaction and the hotspot data, and obtaining a correspondence relationship between candidate hotspot data and candidate business data, wherein the candidate hotspot data refers to hotspot data in the hotspot data related to the business transaction, and the candidate business data refers to business data in the business data related to the hotspot event;

merging and processing the candidate hotspot data according to the correspondence relationship between the candidate hotspot data and candidate business data, and obtaining target hotspot data and target business data corresponding to the target hotspot data.

As a further improvement of the present disclosure, the extracting, from Internet data, hotspot data describing a hotspot event comprises:

determining user access data from the Internet data;

determining, from the user access data, candidate user access data whose mean sudden change rate is greater than a first sudden change rate threshold and whose short-term sudden change rate is greater than a second sudden change rate threshold;

authenticating truth of the candidate user access data and considering candidate user access data passing the truth authentication as the hotspot data describing the hotspot event;

wherein the means sudden change rate is used to characterize a change tendency of an access amount of the user access data in a time period from a first time point to current time; the short-term sudden change rate is used to characterize a change tendency of an access amount of the user access data in a time period from a second time point to current time, the first time point being earlier than the second time point.

As a further improvement of the present disclosure, before determining, from the user access data, candidate user access data whose mean sudden change rate is greater than a first sudden change rate threshold and whose short-term sudden change rate is greater than a second sudden change rate threshold, the method further comprises:

obtaining a first average access amount of the user access data from the first time point to the current time, a second average access amount of the user access data from the second time point to the current time, and a current access amount of the user access data;

dividing the current access amount of the user access data by the first average access amount to obtain the mean sudden change rate;

dividing the current access amount of the user access data by the second average access amount to obtain the short-term sudden change rate.

As a further improvement of the present disclosure, the authenticating truth of the candidate user access data comprises:

judging whether the candidate user access data occurs in word segments of a news title;

if the judgment result is yes, determining that the candidate user access data passes truth authentication; if the judgment result is no, determining that the candidate user access data fails to pass the truth authentication.

As a further improvement of the present disclosure, the performing analysis for association of business data in the whole business market related to a business transaction and the hotspot data, and obtaining a correspondence relationship between candidate hotspot data and candidate business data comprises:

for each kind of business data, determining a similarity of a price trend corresponding to the business data and an access amount trend corresponding to each hotspot data, and determining times of co-occurrence of key words corresponding to the business data in the user access data to which each hotspot data belongs, and if there exists hotspot data with a similarity satisfying a preset similarity condition and the times of co-occurrence being greater than a preset co-occurrence amount threshold, establishing a correspondence relationship between the business data and the above existing hotspot data, and determining the business data and the existing hotspot data as the candidate business data and candidate hotspot data respectively.

As a further improvement of the present disclosure, the merging and processing the candidate hotspot data according to the correspondence relationship between the candidate hotspot data and candidate business data, and obtaining target hotspot data and target business data corresponding to the target hotspot data comprises:

determining the candidate business data corresponding to each of said candidate hotspot data according to the correspondence relationship between the candidate hotspot data and candidate business data;

comparing any two of the candidate hotspot data to judge whether identical candidate business data exist in the candidate business data corresponding to every two candidate hotspot data and whether the number of the identical candidate business data satisfies a preset overlapping condition;

if the judgment result is yes, merging the two candidate hotspot data as a new candidate hotspot data, and merging the candidate business data corresponding to the two candidate hotspot data as a new candidate business data corresponding to the candidate hotspot data, and returning to execute the operation of comparing any two of candidate hotspot data to judge whether identical candidate business data exist in the candidate business data corresponding to every two candidate hotspot data and whether the number of the identical candidate business data satisfies a preset overlapping condition, until obtaining the target hotspot data and target business data corresponding to the target hotspot data when all the judgment results are no.

As a further improvement of the present disclosure, after obtaining the target hotspot data and target business data corresponding to the target hotspot data, the method further comprises:

calculating a hotness value of target hotspot data;

outputting the target hotspot data, target business data corresponding to the target hotspot data, and the hotness value of the target hotspot data.

According to another aspect of the present disclosure, there is provided a hotspot information analysis apparatus, comprising:

an extracting module configured to extract, from Internet data, hotspot data describing a hotspot event;

an analyzing module configured to perform analysis for association of business data in the whole business market related to a business transaction and the hotspot data, and obtain a correspondence relationship between candidate hotspot data and candidate business data, wherein the candidate hotspot data refers to hotspot data in the hotspot data related to the business transaction, and the candidate business data refers to business data in the business data related to the hotspot event;

a merging module configured to merge and process the candidate hotspot data according to the correspondence relationship between the candidate hotspot data and candidate business data, and obtain target hotspot data and target business data corresponding to the target hotspot data.

As a further improvement of the present disclosure, the extracting module comprises: a first determining unit configured to determine user access data from the Internet data;

a second determining unit configured to determine, from the user access data, candidate user access data whose mean sudden change rate is greater than a first sudden change rate threshold and whose short-term sudden change rate is greater than a second sudden change rate threshold;

an authenticating unit configured to authenticate truth of the candidate user access data;

an extracting unit configured to consider candidate user access data passing the truth authentication as the hotspot data describing the hotspot event;

wherein the means sudden change rate is used to characterize a change tendency of an access amount of the user access data in a time period from a first time point to current time; the short-term sudden change rate is used to characterize a change tendency of an access amount of the user access data in a time period from a second time point to current time, wherein the first time point is earlier than the second time point.

As a further improvement of the present disclosure, the apparatus further comprises: an obtaining module configured to obtain a first average access amount of the user access data from the first time point to the current time, a second average access amount of the user access data from the second time point to the current time, and a current access amount of the user access data;

a first calculating module configured to divide the current access amount of the user access data by the first average access amount to obtain the mean sudden change rate, and divide the current access amount of the user access data by the second average access amount to obtain the short-term sudden change rate.

As a further improvement of the present disclosure, the authenticating unit is specifically configured to judge whether the candidate user access data occurs in word segments of a news title; if the judgment result is yes, determine that the candidate user access data passes truth authentication; if the judgment result is no, determine that the candidate user access data fails to pass the truth authentication.

As a further improvement of the present disclosure, the analyzing module is specifically configured to, for each kind of business data, determine a similarity of a price trend corresponding to the business data and an access amount trend corresponding to each hotspot data, and determine times of co-occurrence of key words corresponding to the business data in the user access data to which each hotspot data belongs, and if there exists hotspot data with a similarity satisfying a preset similarity condition and the times of co-occurrence being greater than a preset co-occurrence amount threshold, establish a correspondence relationship between the business data and the above existing hotspot data, and determine the business data and the existing hotspot data as the candidate business data and candidate hotspot data respectively.

As a further improvement of the present disclosure, the merging module comprises:

a third determining unit configured to determine the candidate business data corresponding to each of said candidate hotspot data according to the correspondence relationship between the candidate hotspot data and candidate business data;

a comparing unit configured to compare any two of the candidate hotspot data to judge whether identical candidate business data exist in the candidate business data corresponding to every two candidate hotspot data and whether the number of the identical candidate business data satisfies a preset overlapping condition;

a merging unit configured to, if the judgment result of the comparing unit is yes, merge the two candidate hotspot data as a new candidate hotspot data, and merge the candidate business data corresponding to the two candidate hotspot data as a new candidate business data corresponding to the candidate hotspot data, and trigger the comparing unit to continue to execute the operation of comparing any two of candidate hotspot data to judge whether identical candidate business data exist in the candidate business data corresponding to every two candidate hotspot data and whether the number of the identical candidate business data satisfies a preset overlapping condition;

an obtaining unit configured to obtain the target hotspot data and target business data corresponding to the target hotspot data when all the judgment results of the comparing unit are no.

As a further improvement of the present disclosure, the apparatus further comprises:

a second calculating module configured to calculate a hotness value of target hotspot data;

an output module configured to output the target hotspot data, target business data corresponding to the target hotspot data, and the hotness value of the target hotspot data.

The hotspot information analysis method and apparatus according to the present disclosure extract, from Internet data, hotspot data describing a hotspot event, perform analysis for association of business data in the whole business market related to a business transaction and the hotspot data, and obtain a correspondence relationship between candidate hotspot data in the hotspot data related to the business transaction and candidate business data in the business data related to the hotspot event, then merge and process the candidate hotspot data according to the obtained correspondence relationship, and finally obtain the target hotspot data and the target business data corresponding to the target hotspot data, as the hotspot information in the business market. The technical solution of the present disclosure the method according to the present embodiment does not depend on the user's business experience any longer, and combines the Internet data with business data in the business market related to business transaction, and the data amount is larger. Hence, as compared with the prior art, the present disclosure improves accuracy of the hotspot information obtained from the analysis.

### BRIEF DESCRIPTION OF DRAWINGS

FIG. 1 is a flow chart of a hotspot information analysis method according to an embodiment of the present disclosure;

FIG. 2 is a flow chart of a mode of implementing step 101 according to an embodiment of the present disclosure;

FIG. 3 is a schematic diagram of a candidate hotspot data merge result according to an embodiment of the present disclosure;

FIG. 4 is a flow chart of a hotspot information analysis method according to another embodiment of the present disclosure;

FIG. 5 is a structural schematic diagram of a hotspot information analysis apparatus according to an embodiment of the present disclosure;

FIG. 6 is a structural schematic diagram of a hotspot information analysis apparatus according to another embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

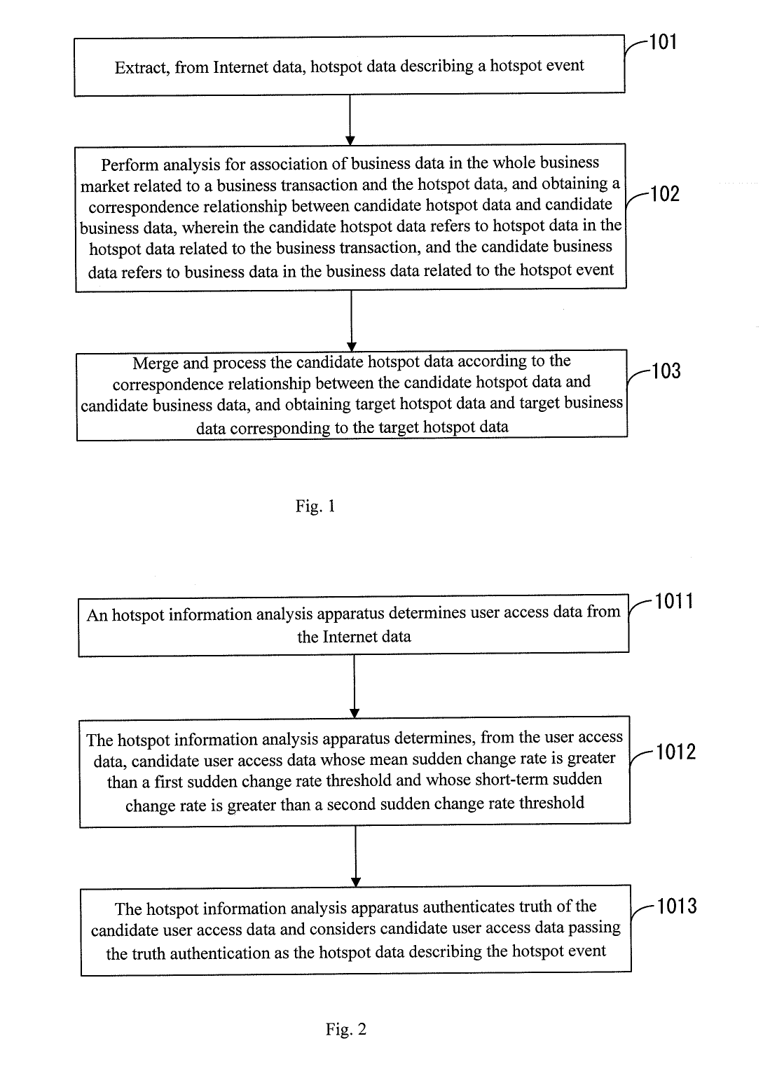

FIG. 1 is a flow chart of a hotspot information analysis method according to an embodiment of the present disclosure. As shown in FIG. 1, the method comprises:

101: extracting, from Internet data, hotspot data describing a hotspot event.

The present embodiment provides a method of organically combining Internet data with business data in a business market to analyze hotspot information in the business market. The Internet data used in the present embodiment may be data (e.g., search terms) used by a search engine or all-network data of the Internet. The all-network data of the Internet may be micro-blog data, page access data and the like.

Specifically, a hotspot information analysis apparatus extracts, from the Internet data, data describing a hotspot event. For ease of description, the data describing the hotspot event is called hotspot data in the present embodiment, and correspondingly, business data in the business market related to the hotspot event is considered as hotspot information in the business market.

Furthermore, to ensure real time of hotspot information resulting from the analysis, the hotspot information analysis apparatus may extract, from the massive Internet data, hotspot data describing a hotspot event on a current day, and determines hotspot information in the business market through subsequent steps and based on the hotspot data describing the hotspot event on the current day.

An optional implementation mode of step 101, as shown in FIG. 2, comprises:

1011: the hotspot information analysis apparatus determines user access data from the Internet data.

The user access data here refers to data used upon accessing to the Internet pages, e.g., it may be data used upon input into the search engine, such as a query word, or search words used by the user during access to the micro-blog.

It is appreciated that usually there are a plurality of the above-mentioned user access data.

1012: the hotspot information analysis apparatus determines, from the user access data, candidate user access data whose mean sudden change rate is greater than a first sudden change rate threshold and whose short-term sudden change rate is greater than a second sudden change rate threshold.

Specifically, for each user access data, the hotspot information analysis apparatus determines the mean sudden change rate and short-term sudden change rate of the user access data, then judges whether the mean sudden change rate of the user access data is greater than the first sudden change rate threshold, and judges whether the short-term sudden change rate of the user access data is greater than the second sudden change rate threshold. If the mean sudden change rate of the user access data is greater than the first sudden change rate threshold and the short-term sudden change rate is greater than the second sudden change rate threshold, the user access data is determined as the candidate user access data.

The present embodiment does not limit the values of the first sudden change rate threshold and second sudden change rate threshold. For example, the first sudden change rate threshold may be 3.0, and the second sudden change rate threshold may be 5.0.

The means sudden change rate of the user access data is used to characterize a change tendency of an access amount of the user access data in a time period from a first time point to current time; correspondingly, the short-term sudden change rate of the user access data is used to characterize a change tendency of an access amount of the user access data in a time period from a second time point to current time, wherein the first time point is earlier than the second time point, that is to say, the mean sudden change rate reflects the change tendency of the access amount of the user access data within a longer time period, whereas the short-term sudden change rate reflects the change tendency of the access amount of the user access data within a recent time period.

Based on the above, before executing the above step 1012, the hotspot information analysis apparatus further needs to obtain a first average access amount of the user access data from the first time point to the current time, a second average access amount of the user access data from the second time point to the current time, and a current access amount of the user access data; divides the current access amount of the user access data by the first average access amount to obtain the mean sudden change rate of the user access data, and divides the current access amount of the user access data by the second average access amount to obtain the short-term sudden change rate of the user access data.

It is appreciated here that the first average access amount is an average access amount of the user access data from the first time point to the current time, and the second average access amount is an average access amount of the user access data from the second time point to the current time.

For example, assume that statistics is carried out for the access amount of the user access data with “day” as a measure unit in the present embodiment, the above current time is the present day. Assume that a time period from the first time point to the present day is five days before the present day, and that the time period from the second time point to the present day is the day before the present day, the first average access amount is a mean value of the access amount of the user access data within five days before the present day, and the second average access amount is an access amount of the user access data in the day before the present day; the current access amount of the user access data is the access amount of the user access data on the present day.

1013: the hotspot information analysis apparatus authenticates truth of the above candidate user access data, and considers candidate user access data passing the truth authentication as the hotspot data describing the hotspot event.

Since truth of some data in the Internet data cannot be ensured, the hotspot information analysis apparatus of the present embodiment authenticates truth of the candidate user access data, and selects candidate user access data passing the truth authentication as the hotspot data, which helps to ensure accuracy of business data in the business market which is obtained from analysis based on the hotspot data and related to the hotspot data.

Optionally, since news generally reports the hotspot event, the hotspot information analysis apparatus may judge whether the candidate user access data occurs in word segments of a news title; if the judgement result is yes, determine that the candidate user access data passes truth authentication; if the judgement result is no, determine that the candidate user access data fails to pass the truth authentication.

It is appreciated that the news title may be obtained from news search in the Internet data, but is not limited to this. For example, the news title may also be obtained and stored in a newspaper or TV manner.

102: performing analysis for association of business data in the whole business market related to the business transaction and the hotspot data to obtain a correspondence relationship between the candidate hotspot data and the candidate business data, wherein the candidate hotspot data refers to hotspot data in the above hotspot data related to the business transaction, and the candidate business data refers to business data in the above business data related to the hotspot event.

First, it is appreciated that some of the above obtained hotspot data are related to the business transaction in the business market to be analyzed in the present embodiment, and some might be irrelevant to the business transaction in the business market to be analyzed in the present embodiment. Likewise, not all business data that is in the business market to be analyzed in the present embodiment and related to the business transaction are relevant to the hotspot event. Hence, after obtaining the hotspot data, the hotspot information analysis apparatus performs analysis for association of business data in the whole business market related to the business transaction and the hotspot data, obtains candidate hotspot data in the hotspot data related to the business transaction and candidate business data in the business data related to the hotspot event, and establishes a correspondence relationship between the candidate hotspot data and the candidate business data.

As appreciated here, there might be many kinds of business transaction in the business market, for example, there are usually stock-like transaction and bond-like transaction in securities market. The stock-like transaction may be classified into many kinds of business transactions according to stock types. The bond-like transaction is also classified into many kinds of business transaction according to bond types. Hence, the business data in the present embodiment may comprise many kinds of business data, with one kind of business data corresponding to one kind of business transaction. For example, in the securities market, transaction of A-share stock is a kind of business transaction, and data related to the transaction of A-share stock is a kind of business data; transaction of B-share stock is a kind of business transaction, and data related to the transaction of A-share stock is a kind of business data; transaction of treasury debt is a kind of business transaction, and data related to the transaction of treasury debt is a kind of business data; transaction of enterprise debt is a kind of business transaction, and data related to transaction of the enterprise debt is a kind of business data.

In an optional embodiment, the implementation mode of step 102 comprises: for each kind of business data, the hotspot information analysis apparatus first determines a similarity of a price trend corresponding to the business data and an access amount trend corresponding to each hotspot data, and determines times of co-occurrence of key words corresponding to the business data in the user access data to which each hotspot data belongs. If there exists hotspot data with a similarity satisfying a preset similarity condition and the times of co-occurrence being greater than a preset co-occurrence amount threshold, establishes a correspondence relationship between the business data and the above existing hotspot data, and determines the business data and the existing hotspot data as the candidate business data and candidate hotspot data respectively. It is appreciated that the user access data to which the hotspot data belongs refers to the user access data of the hotspot data, and the user access data to which the hotspot data belongs may comprise a plurality of user access data.

Values of the above similarity condition and co-occurrence amount threshold are not limited in the present embodiment. For example, the above similarity condition may be range of values, namely, the similarity between the price trend corresponding to the business data and the access amount trend corresponding to the hotspot data is required to be in the range of values, for example, the range of values may be 0.4-1. The co-occurrence amount threshold may be a natural number larger than 10.

It is appreciated here that the price trend corresponding to the business data may be pre-obtained and stored locally in the hotspot information analysis apparatus, or the price may be obtained by the hotspot information analysis apparatus from the business data and analyzed to obtain the price trend. Likewise, the access amount trend corresponding to the hotspot data may be pre-obtained and stored locally in the hotspot information analysis apparatus, or the access amount of the hotspot data is obtained by the hotspot information analysis apparatus through statistics and the access amount trend thereof is analyzed. It is appreciated that the price trend and access amount trend corresponding to the same range of time period need to be used in determining the similarity of the price trend corresponding to the business data and the access amount trend corresponding to the hotspot data.

The key words corresponding to the business data may be information related to business corresponding to the business data, for example, may be abbreviations of enterprise name, business code and business name and the like. The key words may be pre-stored locally in the hotspot information analysis apparatus.

It is appreciated here that through step 102, the correspondence relationship between the candidate hotspot data and the candidate business data is established on the one hand, and on the other hand, the hotspot data and business data are screened, thereby removing hotspot data which is in the hotspot data and irrelevant to the business transaction in the business market to be analyzed in the present embodiment, and removing the business data among the business data irrelevant to the hotspot event.

103: merging and processing the candidate hotspot data according to the correspondence relationship between the candidate hotspot data and candidate business data, and obtaining target hotspot data and target business data corresponding to the target hotspot data.

The candidate hotspot data obtained from step 102 might belong to the same subject matter, but are separate, namely, serve as independent candidate hotspot data, that is to say, the candidate hotspot data obtained at this time and corresponding candidate business data cannot accurately represent hotspot information in the business market, so it is necessary to summarize and merge the candidate hotspot data.

On this basis, the hotspot information analysis apparatus determines the candidate business data corresponding to each candidate hotspot data according to the correspondence relationship between the candidate hotspot data and candidate business data; compares any two of the candidate hotspot data to judge whether identical candidate business data exist in the candidate business data corresponding to every two candidate hotspot data and whether the number of the identical candidate business data satisfies a preset overlapping condition; if the judgment result is yes, the two candidate hotspot data (the two candidate hotspot data refer to candidate hotspot data that that identical candidate business data exist in the corresponding candidate business data and the number of identical candidate business data satisfies the preset overlapping condition) are merged as a new candidate hotspot data, and the candidate business data corresponding to the two candidate hotspot data are merged as a new candidate business data corresponding to the candidate hotspot data; then returns to execute the operation of comparing any two of the candidate hotspot data to judge whether identical candidate business data exist in the candidate business data corresponding to every two candidate hotspot data and whether the number of the identical candidate business data satisfies a preset overlapping condition, until obtains the target hotspot data and target business data corresponding to the target hotspot data when all the judgment results are no.

That is to say, when the candidate business data corresponding to every two candidate hotspot data both do not include identical candidate business data, or they include identical candidate business data but the number of the identical candidate business data does not satisfy the preset overlapping condition, the candidate hotspot data at this time is obtained as the target hotspot data, and the candidate business data corresponding to the candidate hotspot data at this time are considered as the target business data corresponding to the target hotspot data.

The above overlapping condition may be a range of values, i.e., the number of identical candidate business data among the candidate business data corresponding to the two candidate hotspot data should be required in the range of values. Alternatively, the overlapping condition may be a lower limit value, i.e., the number of identical candidate business data among the candidate business data corresponding to the two candidate hotspot data should be required to be greater than the lower limit value.

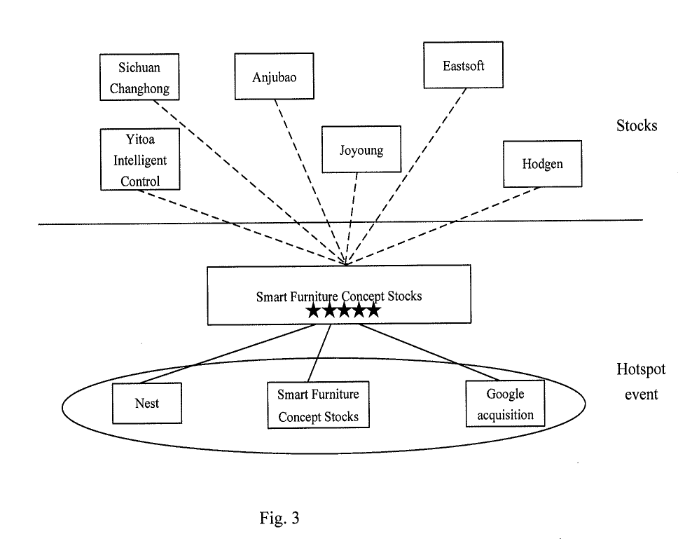

Take securities market as an example for illustration. As shown in FIG. 3, “Nest”, “Smart Furniture Concept Stocks” and “Google acquisition” are respectively different candidate hotspot data. It is assumed that the candidate business data corresponding to “Nest” comprises business data of Sichuan Changhong (Sichuan Changhong for short in FIG. 3), business data of Anjubao (Anjubao for short in FIG. 3), business data of Yitoa Intelligent Control (Yitoa Intelligent Control for short in FIG. 3) and business data of Joyoung Co., Ltd. (briefly Joyoung in FIG. 3), candidate business data corresponding to “Smart Furniture Concept Stocks” comprise business data of Sichuan Chonghong, business data of Eastsoft (briefly Eastsoft in FIG. 3), business data of Yitoa Intelligent Control and business data of Joyoung, and candidate business data corresponding to “Google Acquisition” comprise business data of Sichuan Changhong, business data of Anjubao, business data of Yitoa Intelligent Control and business data of Hodgen (briefly, Hodgen in FIG. 3).

As known from analysis performed according to the above method, “Nest”, “Smart Furniture Concept Stocks” and “Google Acquistion” are literally different but they actually belong to hotspot data of the same subject matter (namely, describing the same hotspot event), so the three candidate hotspot data are merged and processed to obtain target hotspot data, namely, “Smart Furniture Concept Stocks”, and the candidate business data corresponding to “Nest”, “Smart Furniture Concept Stocks” and “Google Acquisition” are merged to obtain business data of Sichuan Changhong, business data of Anjubao, business data of Yitoa Intelligent Control, business data of Joyoung, business data of Eastsoft and business data of Hodgen, as target business data corresponding to “Smart Furniture Concept Stocks”.

As known from the above analysis, the method according to the present embodiment no longer depends on the user's business experience, and instead, the hotspot information analysis apparatus combines the Internet data with business data in the business market related to business transaction and performs analysis to obtain hotspot information in the business market, and overcomes the influence exerted by the user's subjective factor on the analysis procedure. In addition, the method according to the present embodiment employs the Internet data and business data in the whole business market related to the business transaction, and the data amount is larger. Hence, as compared with the prior art, the present embodiment improves accuracy of the hotspot information obtained from the analysis.

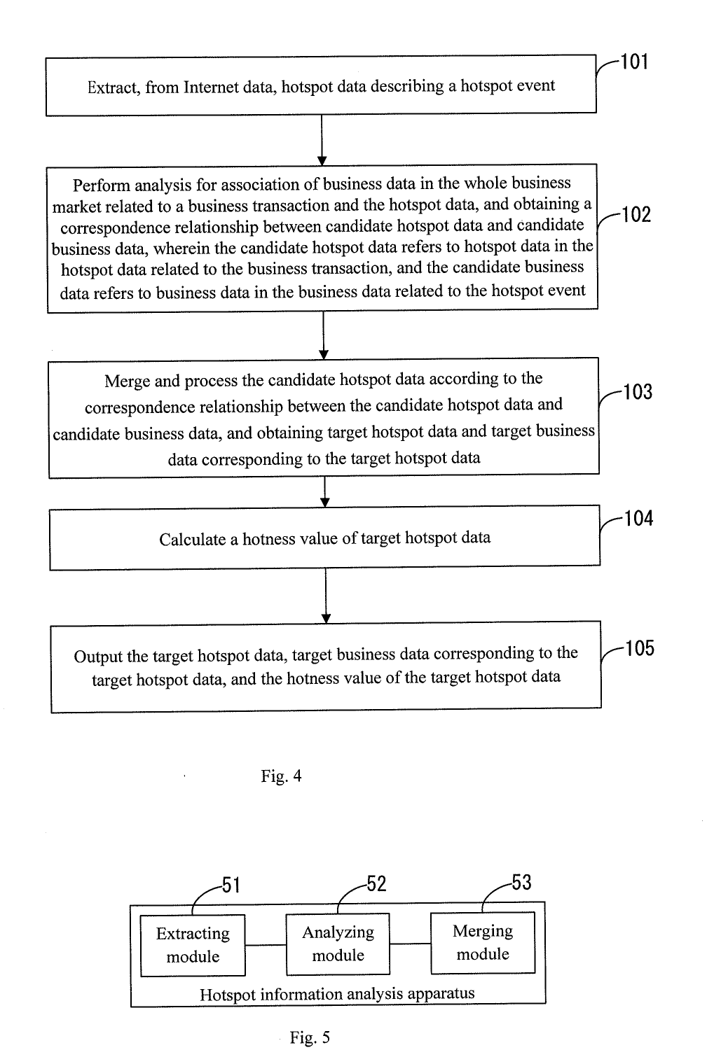

FIG. 4 is a flow chart of a hotspot information analysis method according to another embodiment of the present disclosure. The present embodiment may be implemented based on the embodiment shown in FIG. 1. As shown in FIG. 4, the method, after step 103, further comprises:

104: calculating a hotness value of target hotspot data.

105: outputting the target hotspot data, target business data corresponding to the target hotspot data, and the hotness value of the target hotspot data.

The hotness value reflects a degree of concern for the target hotspot data, assists the user in more visually learning about the degree of concern for the target hotspot data and the target business data, and provides a more visual judgment basis for the user to make a decision.

In an optional implementation mode, the hotspot information analysis apparatus determines a current access amount of the target hotspot data, the mean sudden change rate and short-term sudden change rate of the target hotspot data; performs numerical fitting or regression analysis for the current access amount, the mean sudden change rate and the short-term sudden change rate of the target hotspot data to obtain the hotness value of the target hotspot data.

If the target hotspot data are formed by merging a plurality of candidate hotspot data, a maximum one amount among current access amounts of the plurality of candidate hotspot data which are merged to form the target hotspot data is considered as the current access amount of the target hotspot data, and the mean sudden change rate and short-term sudden change rate of the candidate hotspot data with the maximum access amount are considered as the mean sudden change rate and short-term sudden change rate of the target hotspot data.

As shown in FIG. 3, the hotspot value of “Smart Furniture Concept Stocks” is fiver stars, which indicates an extremely high degree of concern. The hotspot information analysis apparatus calculates the hotness value of the target hotspot data, and outputs the target hotspot data, and its corresponding target business data and hotness value, thereby assisting the user in learning about the degree of concern for different hotspot data and its corresponding target business data, and helping the user to make a decision.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 5 is a structural schematic diagram of a hotspot information analysis apparatus according to an embodiment of the present disclosure. As shown in FIG. 5, the apparatus comprises: an extracting module 51, an analyzing module 52 and a merging module 53.

The extracting module 51 is configured to extract, from Internet data, hotspot data describing a hotspot event.

The analyzing module 52 connected with the extracting module 51 and configured to perform analysis for association of business data in the whole business market related to the business transaction and the hotspot data extracted by the extracting module 51, and obtain a correspondence relationship between the candidate hotspot data and the candidate business data, wherein the candidate hotspot data refers to hotspot data in the hotspot data related to the business transaction, and the candidate business data refers to business data in the business data related to the hotspot event.

The merging module 53 is connected with the analyzing module 52 and configured to merge and process the candidate hotspot data according to the correspondence relationship between the candidate hotspot data and candidate business data, and obtain target hotspot data and target business data corresponding to the target hotspot data.

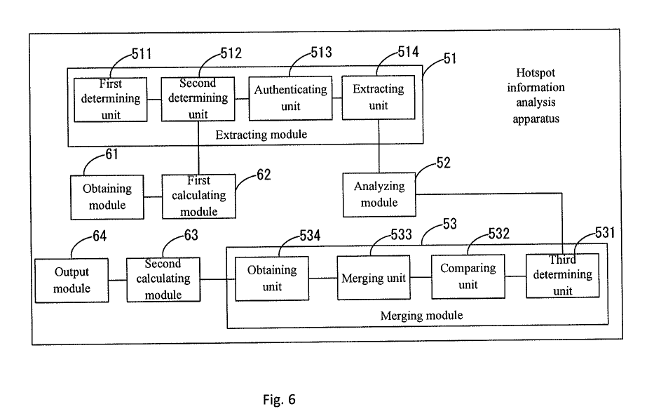

In an optional implementation mode, as shown in FIG. 6, a structure for implementing the extracting module 51 comprises: a first determining unit 511, a second determining unit 512, an authenticating unit 513 and an extracting unit 514.

The first determining unit 511 is configured to determine user access data from the Internet data.

The second determining unit 512 is connected with the first determining unit 511 and configured to determine, from the user access data determined by the first determining unit 511, candidate user access data whose mean sudden change rate is greater than a first sudden change rate threshold and whose short-term sudden change rate is greater than a second sudden change rate threshold.

The authenticating unit 513 is connected with the second determining unit 512 and configured to authenticate truth of the candidate user access data determined by the second determining unit 512.

The extracting unit 514 is connected with the authenticating unit 513 and configured to consider candidate user access data passing the truth authentication of the authenticating unit 513 as the hotspot data describing the hotspot event.

The means sudden change rate is used to characterize a change tendency of an access amount of the user access data in a time period from a first time point to current time; the short-term sudden change rate is used to characterize a change tendency of an access amount of the user access data in a time period from a second time point to current time, wherein the first time point is earlier than the second time point.

In an optional implementation mode, as shown in FIG. 6, the apparatus may further comprise: an obtaining module 61 and a first calculating module 62.

The obtaining module 61 is configured to, before the second determining unit 512 determining candidate user access data whose mean sudden change rate is greater than a first sudden change rate threshold and whose short-term sudden change rate is greater than a second sudden change rate threshold, obtain a first average access amount of the user access data from the first time point to the current time, a second average access amount of the user access data from the second time point to the current time, and a current access amount of the user access data.

The first calculating module 62 is connected with the obtaining module 61 and configured to divide the current access amount of the user access data obtained by the obtaining module 61 by the first average access amount obtained by the obtaining module 61 to obtain the mean sudden change rate, and divide the current access amount of the user access data obtained by the obtaining module 61 by the second average access amount obtained by the obtaining module 61 to obtain the short-term sudden change rate.

The first calculating module 62 is further connected with the second determining unit 512 and configured to provide the means sudden change rate and short-term sudden change rate to the second determining unit 512.

In an optional implementation mode, the authenticating unit 513 is specifically configured to judge whether the candidate user access data occurs in word segments of a news title; if the judgment result is yes, determine that the candidate user access data passes truth authentication; if the judgment result is no, determine that the candidate user access data fails to pass the truth authentication.

In an optional implementation mode, the analyzing module is specifically configured to, for each kind of business data, determine a similarity of a price trend corresponding to the business data and an access amount trend corresponding to each hotspot data, and determine times of co-occurrence of key words corresponding to the business data in the user access data to which each hotspot data belongs, and if there exists hotspot data with a similarity satisfying a preset similarity condition and the times of co-occurrence being greater than a preset co-occurrence amount threshold, establish a correspondence relationship between the business data and the above existing hotspot data, and determine the business data and the existing hotspot data as the candidate business data and candidate hotspot data respectively.

In an optional implementation mode, as shown in FIG. 6, a structure for implementing the merging module 53 comprises: a third determining unit 531, a comparing unit 532, a merging unit 533 and an obtaining unit 534.

The third determining unit 531 is connected with the analyzing module 52 and configured to determine the candidate business data corresponding to each candidate hotspot data according to the correspondence relationship between the candidate hotspot data and candidate business data obtained by the analyzing module 52.

The comparing unit 532 is connected with the third determining unit 531 and configured to compare any two of the candidate hotspot data to judge whether identical candidate business data exist in the candidate business data corresponding to every two candidate hotspot data and whether the number of the identical candidate business data satisfies a preset overlapping condition.

The merging unit 533 is connected with the comparing unit 532 and configured to, if the judgment result of the comparing unit 532 is yes, merge the two candidate hotspot data as a new candidate hotspot data, and merge the candidate business data corresponding to the two candidate hotspot data as new candidate business data corresponding to the candidate hotspot data, and trigger the comparing unit 532 to continue to execute the operation of comparing any two of candidate hotspot data to judge whether identical candidate business data exist in the candidate business data corresponding to every two candidate hotspot data and whether the number of the identical candidate business data satisfies a preset overlapping condition. The obtaining unit 534 is connected with the comparing unit 532 and configured to, when all the judgment results are no, obtain the target hotspot data and target business data corresponding to the target hotspot data.

In an optional implementation mode, as shown in FIG. 6, the apparatus may further comprise: a second calculating module 63 and an output module 64. The second calculating module 63 is connected with the obtaining unit 534 and configured to calculate a hotness value of target hotspot data after the obtaining unit 534 obtains the target hotspot data and target business data corresponding to the target hotspot data.

The output module 64 is connected with the obtaining unit 534 and the second calculating module 63 and configured to output the target hotspot data obtained by the obtaining unit 534, target business data corresponding to the target hotspot data and obtained by the obtaining unit 634, and the hotness value of the target hotspot data calculated by the second calculating module 63.

The hotspot information analysis apparatus according to the present embodiment combines the Internet data with business data in the business market to analyze hotspot information in the business market, and does not depend on the user's business experience. In addition, the apparatus employs the Internet data and business data in the whole business market related to the business transaction, and the data amount is larger. Hence, as compared with the prior art, the present embodiment improves accuracy of the hotspot information obtained from the analysis.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented through other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communication connection as displayed or discussed may be performed via some interfaces, and indirect coupling or communication connection of means or units may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be realized in the form of hardware, or they can be realized with hardware and software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solution of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. A hotspot information analysis method, wherein the method comprises:
extracting, from Internet data, hotspot data describing a hotspot event;
performing analysis for association of business data in the whole business market related to a business transaction and the hotspot data, and obtaining a correspondence relationship between candidate hotspot data and candidate business data, wherein the candidate hotspot data refers to hotspot data in the hotspot data related to the business transaction, and the candidate business data refers to business data in the business data related to the hotspot event;
merging and processing the candidate hotspot data according to the correspondence relationship between the candidate hotspot data and candidate business data, and obtaining target hotspot data and target business data corresponding to the target hotspot data.

2. The method according to claim 1, wherein the extracting, from Internet data, hotspot data describing a hotspot event comprises:
determining user access data from the Internet data;
determining, from the user access data, candidate user access data whose mean sudden change rate is greater than a first sudden change rate threshold and whose short-term sudden change rate is greater than a second sudden change rate threshold;
authenticating truth of the candidate user access data and considering candidate user access data passing the truth authentication as the hotspot data describing the hotspot event;
wherein the mean sudden change rate is used to characterize a change tendency of an access amount of the user access data in a time period from a first time point to current time; the short-term sudden change rate is used to characterize a change tendency of an access amount of the user access data in a time period from a second time point to current time, the first time point being earlier than the second time point.

3. The method according to claim 2, wherein before determining, from the user access data, candidate user access data whose mean sudden change rate is greater than a first sudden change rate threshold and whose short-term sudden change rate is greater than a second sudden change rate threshold, the method further comprises:
obtaining a first average access amount of the user access data from the first time point to the current time, a second average access amount of the user access data from the second time point to the current time, and a current access amount of the user access data;
dividing the current access amount of the user access data by the first average access amount to obtain the mean sudden change rate;
dividing the current access amount of the user access data by the second average access amount to obtain the short-term sudden change rate.

4. The method according to claim 2, wherein the authenticating truth of the candidate user access data comprises:
judging whether the candidate user access data occurs in word segments of a news title;
if the judgment result is yes, determining that the candidate user access data passes truth authentication; if the judgment result is no, determining that the candidate user access data fails to pass the truth authentication.

5. The method according to claim 1, wherein the performing analysis for association of business data in the whole business market related to a business transaction and the hotspot data, and obtaining a correspondence relationship between candidate hotspot data and candidate business data comprises:
for each kind of business data, determining a similarity of a price trend corresponding to the business data and an access amount trend corresponding to each hotspot data, and determining times of co-occurrence of key words corresponding to the business data in the user access data to which each hotspot data belongs, and if there exists hotspot data with a similarity satisfying a preset similarity condition and the times of co-occurrence being greater than a preset co-occurrence amount threshold, establishing a correspondence relationship between the business data and the existing hotspot data, and determining the business data and the existing hotspot data as the candidate business data and candidate hotspot data respectively.

6. The method according to claim 1, wherein the merging and processing the candidate hotspot data according to the correspondence relationship between the candidate hotspot data and candidate business data, and obtaining target hotspot data and target business data corresponding to the target hotspot data comprises:
determining the candidate business data corresponding to each of said candidate hotspot data according to the correspondence relationship between the candidate hotspot data and candidate business data;
comparing any two of the candidate hotspot data to judge whether identical candidate business data exist in the candidate business data corresponding to every two candidate hotspot data and whether the number of the identical candidate business data satisfies a preset overlapping condition;
if the judgment result is yes, merging the two candidate hotspot data as a new candidate hotspot data, and merging the candidate business data corresponding to the two candidate hotspot data as a new candidate business data corresponding to the candidate hotspot data, and returning to execute the operation of comparing any two of candidate hotspot data to judge whether identical candidate business data exist in the candidate business data corresponding to every two candidate hotspot data and whether the number of the identical candidate business data satisfies a preset overlapping condition, until obtaining the target hotspot data and target business data corresponding to the target hotspot data when all the judgment results are no.

7. The method according to claim 1, wherein after obtaining the target hotspot data and target business data corresponding to the target hotspot data, the method further comprises:
calculating a hotness value of target hotspot data;
outputting the target hotspot data, target business data corresponding to the target hotspot data, and the hotness value of the target hotspot data.

8-14. (canceled)

15. An apparatus, comprising
one or more processor;
a memory;
one or more programs stored in the memory and configured to execute the following operations when executed by the one or more processors:
extracting, from Internet data, hotspot data describing a hotspot event;
performing analysis for association of business data in the whole business market related to a business transaction and the hotspot data, and obtaining a correspondence relationship between candidate hotspot data and candidate business data, wherein the candidate hotspot data refers to hotspot data in the hotspot data related to the business transaction, and the candidate business data refers to business data in the business data related to the hotspot event;
merging and processing the candidate hotspot data according to the correspondence relationship between the candidate hotspot data and candidate business data, and obtaining target hotspot data and target business data corresponding to the target hotspot data.

16. A non-volatile computer storage medium in which one or more programs are stored, an apparatus being enabled to execute the following operations when said one or more programs are executed by the apparatus:
extracting, from Internet data, hotspot data describing a hotspot event;
performing analysis for association of business data in the whole business market related to a business transaction and the hotspot data, and obtaining a correspondence relationship between candidate hotspot data and candidate business data, wherein the candidate hotspot data refers, to hotspot data in the hotspot data related to the business transaction, and the candidate business data refers to business data in the business data related to the hotspot event;
merging and processing the candidate hotspot data according to the correspondence relationship between the candidate hotspot data and candidate business data, and obtaining target hotspot data and target business data corresponding to the target hotspot data.

17. The Apparatus according to claim 15, wherein the operation of extracting from Internet data hotspot data describing a hotspot event comprises:
determining user access data from the Internet data;
determining, from the user access data, candidate user access data whose mean sudden change rate is greater than a first sudden change rate threshold and whose short-term sudden change rate is greater than a second sudden change rate threshold;
authenticating truth of the candidate user access data and considering candidate user access data passing the truth authentication as the hotspot data describing the hotspot event;
wherein the mean sudden change rate is used to characterize a change tendency of an access amount of the user access data in a time period from a first time point to current time; the short-term sudden change rate is used to characterize a change tendency of an access amount of the user access data in a time period from a second time point to current time, the first time point being earlier than the second time point.

18. The Apparatus according to claim 17, wherein before determining, from the user access data, candidate user access data whose mean sudden change rate is greater than a first sudden change rate threshold and whose short-term sudden change rate is greater than a second sudden change rate threshold, the operation further comprises:
obtaining a first average access amount of the user access data from the first time point to the current time, a second average access amount of the user access data from the second time point to the current time, and a current access amount of the user access data;
dividing the current access amount of the user access data by the first average access amount to obtain the mean sudden change rate;
dividing the current access amount of the user access data by the second average access amount to obtain the short-term sudden change rate.

19. The Apparatus according to claim 17, wherein the authenticating truth of the candidate user access data comprises:
judging whether the candidate user access data occurs in word segments of a news title;
if the judgment result is yes, determining that the candidate user access data passes truth authentication; if the judgment result is no, determining that the candidate user access data fails to pass the truth authentication.

20. The Apparatus according to claim 15, wherein the performing analysis for association of business data in the whole business market related to a business transaction and the hotspot data, and obtaining a correspondence relationship between candidate hotspot data and candidate business data comprises:
for each kind of business data, determining a similarity of a price trend corresponding to the business data and an access amount trend corresponding to each hotspot data, and determining times of co-occurrence of key words corresponding to the business data in the user access data to which each hotspot data belongs, and if there exists hotspot data with a similarity satisfying a preset similarity condition and the times of co-occurrence being greater than a preset co-occurrence amount threshold, establishing a correspondence relationship between the business data and the existing hotspot data, and determining the business data and the existing hotspot data as the candidate business data and candidate hotspot data respectively.

21. The Apparatus according to claim 15, wherein the merging and processing the candidate hotspot data according to the correspondence relationship between the candidate hotspot data and candidate business data, and obtaining target hotspot data and target business data corresponding to the target hotspot data comprises:
determining the candidate business data corresponding to each of said candidate hotspot data according to the correspondence relationship between the candidate hotspot data and candidate business data;
comparing any two of the candidate hotspot data to judge whether identical candidate business data exist in the candidate business data corresponding to every two candidate hotspot data and whether the number of the identical candidate business data satisfies a preset overlapping condition;
if the judgment result is yes, merging the two candidate hotspot data as a new candidate hotspot data, and merging the candidate business data corresponding to the two candidate hotspot data as a new candidate business data corresponding to the candidate hotspot data, and returning to execute the operation of comparing any two of candidate hotspot data to judge whether identical candidate business data exist in the candidate business data corresponding to every two candidate hotspot data and whether the number of the identical candidate business data satisfies a preset overlapping condition, until obtaining the target hotspot data and target business data corresponding to the target hotspot data when all the judgment results are no.

22. The Apparatus according to claim 15, wherein after obtaining the target hotspot data and target business data corresponding to the target hotspot data, the operation further comprises:
calculating a hotness value of target hotspot data;
outputting the target hotspot data, target business data corresponding to the target hotspot data, and the hotness value of the target hotspot data.
